(19) United States
(12) Patent Application Publication
(10) Pub. No.: US 2026/0145954 A1
(43) Pub. Date: May 28, 2026

(54) PROCESS FOR CONTINUOUS SYNTHESIS OF ZSM-5 ZEOLITE

(71) Applicant: ARKEMA FRANCE, Puteaux (FR)

(72) Inventors: Elsy EL HAYEK, Lacq (FR); Heidy RAMIREZ-MENDOZA, Lacq (FR); Cécile LUTZ, Lacq (FR); Mélanie VAUTHRIN, Lacq (FR); Sylvie SZENDROVICS, Lacq (FR)

(73) Assignee: ARKEMA FRANCE, Puteaux (FR)

(21) Appl. No.: 19/121,736

(22) PCT Filed: Oct. 18, 2023
(86) PCT No.: PCT/FR2023/051628

§ 371 Date: Apr. 16, 2025

(30) Foreign Application Priority Data
Oct. 19, 2022 (FR) FR2210820

(51) Int. Cl. C01B 39/38

(52) U.S. Cl. CPC C01B 39/38; C01P 2002/72

(57) ABSTRACT

The present invention relates to a process for the continuous synthesis of zeolite crystals of type ZSM-5 comprising the continuous feeding of a tubular reactor with a synthesis medium comprising a source of silica, a source of alumina and seeds, rapid heating of the synthesis medium to a value of between 100° C. and 300° C., crystallization at a temperature at least equal to or higher than the temperature of the previous step, and continuous recovery of zeolite crystals of type ZSM-5.

### CROSS-REFERENCE TO RELATED APPLICATIONS

This application is the United States National Phase of PCT International Patent Application No. PCT/FR 2023/051628, filed on Oct. 18, 2023, which claims the benefit of French Patent Application No. FR 2210820, filed on Oct. 19, 2022, the disclosure of each of which is hereby incorporated by reference herein in its entirety for all purposes.

### BACKGROUND OF THE INVENTION

The present invention relates to the field of zeolites and more particularly to the field of synthetic zeolites, and more particularly to the preparation of synthetic zeolites, in particular zeolites with a high silicon content, and most particularly to the continuous preparation of synthetic zeolites with a high silicon content, with high levels of purity and crystallinity.

Zeolites are crystalline aluminosilicates in which the proportion of silicon and aluminium, often referred to as Si/Al atomic ratio, is highly variable. Moreover, several crystalline structures are possible for the same Si/Al ratio and several zeolites with different Si/Al ratios may have the same crystalline structure. The synthesis routes are very diverse and more or less easy to implement and to carry out, depending on the targeted Si/Al ratio and the desired crystalline structure.

In particular, the zeolite known as ZSM-5, which is a zeolite of MFI structure, is a microporous crystalline aluminosilicate involved in various industrial applications such as adsorption, catalysis, separation and ion exchange. The industry therefore needs relatively large quantities of this ZSM-5 zeolite, which is manufactured synthetically.

The ZSM-5 zeolite synthesis routes known today suffer, however, from numerous disadvantages, among which mention may be made of the use of organic structuring agents, relatively long synthesis times, for example from a few tens of hours to a few days, as well as the use of autoclaves, since synthesis most often requires high temperatures and therefore pressurization.

In addition, conventional industrial syntheses of ZSM-5 are most often carried out with large installations, generally with heating of the synthesis gel and/or of the reaction medium, by steam injection and/or by a jacket; this causes high energy costs and often leads to problems of production regularity.

Syntheses of ZSM-5 with organic structuring agent are described, for example, in documents U.S. Pat No. 7,244,409 and AU2014413311. These syntheses require, on the one hand, the presence of organic structuring agent in the reaction medium and, on the other hand, the destruction, generally by calcination, after synthesis of the zeolite, of this organic structuring agent.

The use of organic structuring agents is therefore harmful to the environment. Furthermore, the use of structuring agents leads to high manufacturing costs and an additional industrial step of removing said organic structuring agent.

In order to overcome these drawbacks, other publications mention syntheses without an organic structuring agent, such as, for example, publication US2013144100 which describes a synthesis of large-crystal ZSM-5 zeolites. In this description, however, the process uses gluconic acid or its salts as aluminium complexing agent(s). Moreover, the duration of synthesis (about 2 hours to 100 hours) remains too great for efficient, economical and profitable industrial syntheses.

Patent U.S. Pat. No. 5,240,892 describes batch syntheses lasting several hours, in which the crystallization step is carried out in an autoclave. Patent U.S. Pat. No. 6,261,534 also describes a process for the synthesis of ZSM-5 zeolite, without a structuring agent but in the presence of two sources of metal and non-metal oxides whose molar ratio is greater than 12. In addition, the synthesis times are long, for example greater than 24 hours.

Among the processes carried out continuously in tubular reactors, mention may be made in particular of international application WO2017216236 and international application WO2018167414, both of which only exemplify syntheses of zeolites whose Si/Al ratio is low (chabazite, zeolites A and X).

The main objective of the present invention is therefore to propose a new method for preparing ZSM-5 zeolite that avoids the aforementioned drawbacks. In particular, an objective of the present invention is to provide a process for synthesizing ZSM-5 zeolite that is easy to industrialize, economical and efficient. Another objective of the invention is to provide a process for synthesizing ZSM-5 zeolite that is easy to industrialize, economical and efficient, with short synthesis times. Yet another objective is to provide a process for synthesizing ZSM-5 zeolite that is easy to industrialize, economical and efficient, with short synthesis times, the zeolite obtained being in the form of crystals of a size compatible with industrial uses, and in particular with sizes greater than nanometric sizes.

The Applicant has now discovered that the aforementioned objectives can be achieved in whole or at least in part by virtue of the invention which is now detailed in the following description.

### SUMMARY OF THE INVENTION

Thus, a first subject of the invention consists of a process for the continuous synthesis of ZSM-5 zeolite that does not require the use of an organic structuring agent. The process of the invention also allows syntheses which are able to dispense with a maturing step, and which have relatively short crystallization times, of generally less than 5 hours, or even less than 4 hours and, more generally still, less than 3 hours. The process according to the present invention is entirely suitable for the continuous synthesis of ZSM-5 crystals.

### BRIEF DESCRIPTION OF THE DRAWINGS

FIGS. 1, 2 and 3 represent the X-ray diffractograms of the crystals obtained respectively in Examples 1, 2 and 3.

### DETAILED DESCRIPTION OF THE INVENTION

In the present invention, and unless otherwise indicated, all ranges of values introduced by the expressions “from . . . to . . . ” or “between and . . . ” , or similar expressions intended to encompass two values, are understood to be with limits included.

More particularly, the present invention relates to the process for the continuous synthesis of zeolite crystals of the ZSM-5 type, said process comprising at least the following steps a) to d):
a) continuous feeding of a tubular reactor with a synthesis medium comprising a source of silica, a source of alumina and seeds;
b) heating of the synthesis medium for a period equivalent to the residence time in at most ⅓, preferably ¼, with preference ⅕ of the total length of the tubular reactor, up to a value of between 100° C. and 300° C.;
c) crystallization at a temperature at least equal to or higher than the temperature of the previous step;
d) continuous recovery of zeolite crystals of ZSM-5 type, of size between 0.2 μm and 20.0 μm, preferably between 0.2 μm and 10.0 μm, better still between 0.3 μm and 7.0 μm, advantageously between 0.3 μm and 5.0 μm.

The ZSM-5 type zeolite crystals obtained by the process of the invention defined above generally have a size of between 0.2 μm and 20.0 μm, preferably between 0.2 μm and 10.0 μm, better still between 0.3 μm and 7.0 μm, advantageously between 0.3 μm and 5.0 μm.

In the process of the invention, the reactor is a tubular reactor, optionally but preferably equipped with one or more stirring systems chosen from mechanical stirring and oscillation stirring systems, and also combinations of one or more mechanical stirring systems with one or more oscillation stirring systems. However, only one type of stirring system, either mechanical or oscillatory, is preferred for the process of the present invention.

More preferably still, the process of the present invention comprises only one stirring system, either mechanical or oscillatory. According to one preferred embodiment, the process of the invention comprises a single mechanical stirring system. According to another preferred embodiment, the method of the invention comprises a single stirring system generated by an oscillatory movement.

The stirring means may be of any type well known to those skilled in the art, and for example and in a non-limiting manner, when the reactor is a tubular reactor adapted to be operated continuously, this tubular reactor may be provided with restrictions (such as rings, baffles and the like), may be equipped with one or more stirring systems (stirring shaft equipped with several stirring wheels, cascade of stirrers distributed along the reactor), one or more oscillating or pulsating systems (allowing generation of a reciprocating movement of the reaction medium by means for example of piston, membrane, head-to-tail pumps), and others, as well as two or more of these techniques combined.

In a preferred embodiment of the invention, the process is carried out in a tubular reactor equipped with restrictions and equipped with a system making it possible to impart pulsations to the fluid circulating in the reactor, as described, for example, in application US20090304890 from NiTech.

In a preferred embodiment of the process of the invention, the tubular reactor makes it possible to ensure a continuous flow in a straight line, optionally with one or more curves. The tubular reactor generally and most often has a constant internal diameter which can vary in large proportions, and preferably between 1 mm and 1000 mm, preferably between 1 mm and 800 mm, more preferably between 1 mm and 500 mm, for example between 3 mm and 400 mm.

The total length of the tubular reactor can also vary in large proportions and is generally between 0.5 m and 100 m, preferably between 0.8 m and 80 m, and with preference between 1 m and 70 m.

The volume of the reactor is to be adapted as a function of the zeolite production requirements. Typically, it may vary between 0.04 m³ and 10m³ , preferably between 0.05 m³ and 5 m³, with a length/diameter shape factor typically greater than 100, preferably greater than 140, more preferably greater than 180. Depending on the geometry of the reactor, the flow rate can typically vary between 0.02 m³ h⁻¹ and 20 m³h⁻¹.

The reactor used for the process of the present invention further comprises at least one heating system for at least a portion of the length of the reactor, and optionally a heat insulation system for all or part of the length of the reactor. The reactor may also comprise one or more ultrasound sources in order to promote the crystallization and/or the formation of well-individualized crystals, that is to say without or with few aggregates.

Said at least one heating system may be of any type well known to the person skilled in the art, and for example chosen from steam injection, by jacket, by addition of a microwave source, and by combination of one or more of the aforementioned means. The heating system must allow a rapid rise in temperature, up to the crystallization temperature, as will be described later.

The synthesis medium is prepared continuously, by mixing a source of silica and a source of alumina. This synthesis medium is prepared by mixing the components of said synthesis medium by any means well known to those skilled in the art and more particularly by means of a mixer, for example and preferably a shear mixer of the rotor/stator type.

By silica source is meant any source well known to the person skilled in the art and in particular a solution, preferably aqueous, of silicate, in particular of silicate or orthosilicate of alkali or alkaline earth metal, for example of sodium, or of colloidal silica or alternatively of tetraethyl orthosilicate, the latter being not preferred.

By alumina source is meant any source of alumina well known to the person skilled in the art and in particular a solution, preferably aqueous, of aluminium sulfate, aluminium nitrate, aluminate, in particular alkali metal or alkaline earth metal aluminate, for example sodium aluminate.

In a preferred embodiment, the synthesis medium comprises:
a source of silica which is an aqueous solution of silicate or orthosilicate of an alkali or alkaline earth metal, for example and preferably sodium, or colloidal silica, and
a source of alumina which is an aqueous solution of aluminium sulfate, aluminium nitrate, aluminate, in particular alkali metal or alkaline earth metal aluminate, for example sodium aluminate.

The term “seeds” is understood to mean any seed source well known to a person skilled in the art and in particular a nucleating solution, or zeolite crystals of MFI type (ZSM-5 or Silicalite-1) or MEL type, optionally ground or cryo-ground beforehand preferably to a submicron size.

The seeds are introduced continuously, either in a mixture with the silica source and/or the alumina source, or after the introduction of the silica and alumina sources. The introduction of the seeds is carried out in a most preferred way upstream of the crystallization step. The percentage by weight of the seeds relative to the total weight of the synthesis medium is generally and most often between 0.5% and 20%, preferably between 1% and 10%.

The SiO₂/Al₂O₃ molar ratio in the synthesis medium, before introduction of the seeds, is generally between 16 and 400, preferably between 16 and 350, with preference between 20 and 300, limits included. The H₂O/SiO₂ molar ratio is between 1 and 100, preferably between 3 and 90 and with preference between 5 and 70, limits included. The Na₂O/SiO₂ molar ratio is between 0.01 and 0.9, preferably between 0.01 and 0.7, with preference between 0.01 and 0.5, limits included.

According to yet another preferred embodiment, the synthesis medium, before introduction of the seeds, has:
an SiO₂/Al₂O₃ molar ratio of between 16 and 400, preferably between 16 and 350, with preference between 20 and 300, limits included,
an H₂O/SiO₂ molar ratio of between 1 and 100, preferably between 3 and 90 and with preference between 5 and 70, limits included, and
an Na₂O/SiO₂ molar ratio of between 0.01 and 0.9, preferably between 0.01 and 0.7, with preference between 0.01 and 0.5, limits included.

In one embodiment, the synthesis medium used in the process of the invention may comprise one or more auxiliary agents, such as, for example, one or more organic solvents, advantageously chosen from water-soluble solvents and, for example, those chosen from alcohols, advantageously an alcohol chosen from propanol, butanol, pentanol, hexanol, preferably butanol.

The heating step may be carried out according to any means known to those skilled in the art, provided that the synthesis medium rapidly reaches the desired temperature, typically between 100° C. and 300° C. The rapid heating can be simply expressed as a time equivalent to the residence time in at most ⅓, preferably ¼, with preference ⅕ of the total length of the tubular reactor. This fraction of length may, in some cases, and if desired, be up to 1/10 of the total length of the tubular reactor. The heating can be carried out according to any method well known to the person skilled in the art and, for example, by steam injection, by jacket, or by adding a microwave source, or by combining one or more of the aforementioned means.

The process of the present invention is characterized in particular by the fact that, and this is the main object of the present invention, the heating of the synthesis medium up to the crystallization temperature is carried out very quickly.

Indeed, it has been discovered quite surprisingly that this rapid heating makes it possible in particular to obtain zeolite crystals of high purity, without impurities, or at least with only a few traces of impurities.

Thus, and as indicated above, the reaction medium is fed continuously into the tubular reactor and is immediately heated in a heating zone corresponding to a duration equivalent to at most ⅓, preferably ¼ and with preference ⅕, or even up to 1/10 of the total length of the tubular reactor. At the end of this heating zone, the reaction medium, at a temperature of 100° C. to 300° C., continues its advance into the tubular reactor where it crystallizes to form the desired crystals of ZSM-5 zeolite.

According to the present invention, the crystallization step is carried out at high temperatures and under pressure, the pressure being at least equal to the autogenous pressure. Advantageously, the crystallization step is carried out at a temperature ranging from 100° C. to 300° C., preferably from 150° C. to 220° C., more preferably from 170° C. to 210° C., and most preferably from 180° C. to 210° C.

The duration of the crystallization step can vary in large proportions and is generally between a few minutes and several hours, most often for a period varying from 30 minutes to 5 hours, preferably from 30 minutes to 3 hours, more preferably from 1 hour to 2.5 hours.

It should be understood that by virtue of the rapid heating of the synthesis medium for a period equivalent to the residence time in at most ⅓, preferably ¼ and with preference ⅕ of the total length of the tubular reactor, up to a value of between 100° C. and 300° C., as indicated above, the crystallization time is equivalent respectively to at least ⅔, preferably ¾ and with preference ⅘ of the total length of the tubular reactor.

As indicated above, the flow rate in the tubular reactor can vary in large proportions and is generally and typically between 0.02 m³ h⁻¹ and 20 m³h⁻¹, depending on the geometry of the reactor, the desired synthesis rates, the different types of equipment used for mixing starting solutions, for attaining the crystallization temperature, etc.

Yet another advantage of the process of the invention, a direct consequence in particular of the rapid heating up to the crystallization temperature, is embodied in very short durations for synthesis of ZSM-5 crystals, most particularly when compared with the durations of industrial synthesis available today in the prior art.

Moreover, the synthesis process of the present invention is a continuous process, which represents a not inconsiderable advantage compared with conventional industrial synthesis processes, generally requiring large-sized installations, with production batches which are often not very homogeneous in terms of the quality of the manufactured product. The continuous process according to the present invention thus provides numerous advantages as indicated above, to which can be added the reduction in the size of the installations, the reduction in energy expenditures and the improvement in the regularity of the quality of the production.

The continuous process according to the present invention ensures a homogeneous mixture of the reaction medium and in particular during crystallization, which makes it possible to obtain, in an entirely simple and efficient manner, crystals having a homogeneous particle size and morphology. Thus, the process of the invention continuously generates ZSM-5 zeolite crystals having an Si/Al ratio of 10 to 60, preferably 10 to 50, preferably 12 to 40.

According to one embodiment, the crystals obtained by virtue of the process of the present invention have a size greater than 0.2 μm, and preferably greater than 0.3 μm, limits included, and, most often, a size of between 0.2 μm and 20.0 μm, preferably between 0.2 μm and 10.0 μm, better still between 0.3 μm and 7.0 μm, advantageously between 0.3 μm and 5.0 μm.

The estimation of the number-average size of the zeolite crystals is carried out by observation with a scanning electron microscope (SEM). In order to estimate the size of the zeolite crystals in the samples, a set of images is taken at a magnification of at least 5000. The length of at least 200 crystals is then measured using dedicated software, for example the Smile View software from the publisher LoGraMi. The accuracy is of the order of 3%. The crystals of ZSM-5 are pure; this purity is verified by the absence of parasitic phases identified by DRX.

Thus, the crystals obtained according to the process of the present invention are generally and most often characterized by a Dubinin volume equal to or greater than 0.10g.cm⁻³, preferably equal to or greater than 0.13g.cm⁻³, preferably equal to or greater than 0.14g.cm⁻³ . The Dubinin volume (or microporous volume Vmi) is determined in a conventional manner known to those skilled in the art, in particular from the measurement of the adsorption isotherm of a gas at its liquefaction temperature, for example nitrogen, argon, oxygen, and others. Preferably, nitrogen is used.

Prior to this adsorption measurement, the zeolite crystals of the invention are degassed between 300° C. and 450° C. for a period of 9 hours to 16 hours, under vacuum (P<6.7.10-4 Pa). For example, for a zeolite with MFI structure such as ZSM-5, the nitrogen adsorption isotherm at 77K is then measured on an ASAP 2020 type apparatus from Micromeritics, taking at least 35 measurement points at relative pressures with a P/Po ratio of between 0.002 and 1. The microporous volume is determined according to the equation of Dubinin and Raduskevitch from the resulting isotherm, employing standard ISO 15901-3:2007. The microporous volume thus evaluated is expressed in cm³ of liquid adsorbent per gram of anhydrous adsorbent. The measurement uncertainty is ±0.003g/cm³.

As indicated above, the process of the present invention makes it possible in particular to dispense with the use of an organic structuring agent. In addition to the advantage of simplification of implementation, the absence of the use of a structuring agent significantly reduces the impact on the environment, these organic agents being very often toxic. Another advantage is that the process without a structuring agent avoids an additional step of removing the organic structuring agent, thus allowing a reduction in the costs of zeolite production.

Without wishing to be bound by the theory, it appears that the process of the present invention, in which the reaction medium is rapidly brought to the crystallization temperature, facilitates the production of a well-crystallized, homogeneous and impurity-free material which is characterized by crystals having a relative crystallinity, measured according to standard ASTM D5758, of between 95% and 140%, preferably between 95% and 135%, most preferably between 95% and 130%.

The invention is now illustrated with the aid of the examples which follow and which in no way limit the invention, the scope of which is defined by the claims appended to the present description.

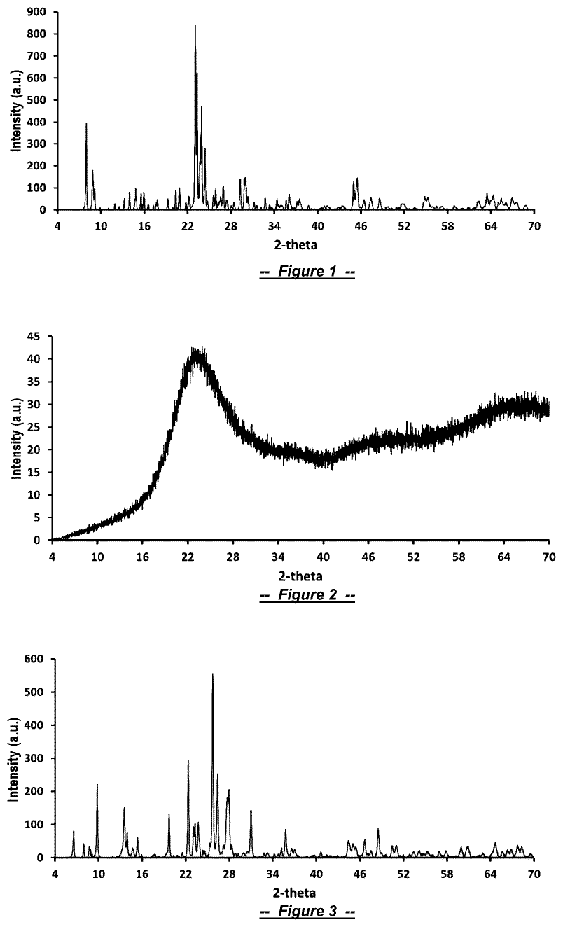

FIGS. 1, 2 and 3 represent the X-ray diffractograms of the crystals obtained respectively in Examples 1, 2 and 3.

### EXAMPLES

### Example 1 (According to the Invention):

Continuous synthesis of ZSM-5, with addition of seeds

The continuous synthesis of the ZSM-5 zeolite consists in feeding a tubular reactor with the solution of silicate, aluminate and seeds. A sodium silicate solution of composition 6.9 Na₂O 93 SiO₂-951 H₂O is prepared. A sodium aluminate solution of composition 1.4 Na₂O-1 Al₂O₃ 311 H₂O is prepared. The seeds consist of crystals of ZSM-5 (Alfa AESAR, CAS 1318-02-1) in a proportion of 2% by weight relative to the weight of the synthesis medium.

The synthesis medium is thus prepared by simultaneously feeding the chamber of the in-line shear mixer with the aid of two pumps: the flow rate of the aluminate solution is equal to 100 g/min and that of silicate is equal to 450 g/min. The seeds are added just before entry into the tubular reactor. The synthesis medium is heated in the tubular reactor by means of a jacket in order to reach the crystallization temperature of 200° C. over a length equivalent to ⅙ of the total length of the tubular reactor. The feed rate is fixed in order to guarantee a total residence time in the tubular reactor of 120 minutes. At the end of this synthesis, a pure ZSM-5 zeolite, that is to say exhibiting a diffractogram strictly characteristic of an MFI type zeolite, is obtained (see X-ray diffractrogram, FIG. 1), and has a Dubinin volume of 0.14 g.cm⁻³.

### Example 2 (Comparative):

### Continuous Synthesis of ZSM-5, Without Addition of Seeds

In this example of continuous synthesis of ZSM-5 zeolite, a solution of sodium silicate of composition 6.9 Na₂O-93 SiO₂-951 H₂O and a solution of sodium aluminate of composition 1.4 Na₂O-1 Al₂O₃-311 H₂O are fed to a tubular reactor.

The synthesis medium is prepared continuously, using a shear mixer of the rotor/stator type, by mixing the aluminate solution and the silicate solution simultaneously. The synthesis medium is thus prepared by simultaneously feeding the chamber of the Silverson in-line shear mixer using two peristaltic pumps: the flow rate of the aluminate solution is equal to 100 g min⁻¹ and that of silicate is equal to 450 g min⁻¹. The synthesis medium is heated in the tubular reactor by means of a jacket in order to reach the crystallization temperature of 200° C. over a length equivalent to ⅙ of the total length of the tubular reactor. The feed rate is fixed in order to guarantee a residence time in the tubular reactor of 120 minutes.

The X-ray diffractogram (FIG. 2) of the product obtained from this synthesis shows that, in the absence of seeds, an amorphous product is obtained.

### Example 3 (Comparative)

### Batchwise Synthesis of ZSM-5, With Addition of Seeds

The batch synthesis of the ZSM-5 zeolite consists in introducing into a batch reactor a sodium silicate solution, a sodium aluminate solution and seeds.

A silicate solution of composition 6.9 Na₂O 93 SiO₂ 951 H₂O is prepared. An aluminate solution of composition 1.4 Na₂O 1 Al₂O₃ 311 H₂O is prepared. The seeds consist of crystals of ZSM-5 (Alfa AESAR, CAS 1318-02-1) in a proportion of 2% by weight relative to the weight of the synthesis medium.

The synthesis medium is prepared by mixing the sodium silicate solution, the sodium aluminate solution and then the seeds in the batch reactor. The reactor is then heated to 200° C. by a jacket. The residence time in the reactor is 2 hours.

The X-ray diffractogram (FIG. 3) of the product obtained from this synthesis shows the presence of the ZSM-5 of MFI structural type but also the presence of another parasitic phase, a zeolite of MOR structural type.

1. A process for the continuous synthesis of ZSM-5 zeolite crystals, the process comprising at least the following steps a) to d):
a) continuous feeding of a tubular reactor with a synthesis medium comprising a source of silica, a source of alumina and seeds;
b) heating of the synthesis medium for a period equivalent to the residence time in at most ⅓ of the total length of the tubular reactor, up to a value of between 100° C. and 300° C.;
c) crystallization at a temperature at least equal to or higher than the temperature of the previous step;
d) continuous recovery of zeolite crystals of type ZSM-5.

2. The process according to claim 1, wherein the tubular reactor is equipped with one or more stirring systems selected from mechanical stirring and oscillation stirring systems, as well as combinations of one or more mechanical stirring systems with one or more oscillation stirring systems.

3. The process according to claim 1, wherein tubular reactor has a constant internal diameter of between 1 mm and 1000 mm.

4. The process according to claim 1, wherein the seeds are chosen from nucleating solution and zeolite crystals of MFI or MEL type.

5. The process according to claim 1, wherein the percentage by weight of the seeds relative to the total weight of the synthesis medium is between 0.5% and 20%.

6. The process according to claim 1, wherein the synthesis medium comprises:
a source of silica which is an aqueous solution of alkali or alkaline earth metal silicate or orthosilicate, or colloidal silica, and
a source of alumina which is an aqueous solution of aluminium sulfate, aluminium nitrate, an aluminate.

7. The process according to claim 6 wherein the synthesis medium, prior to introduction of the seeds, has:
an SiO₂/Al₂O₃ molar ratio of between 16 and 400, limits included,
an H₂O/SiO₂ molar ratio of between 1 and 100, limits included, and
an Na₂O/SiO₂ molar ratio of between 0.01 and 0.9, limits included.

8. The process according to claim 1, wherein the crystallization step is carried out at a temperature ranging from 100° C. to 300° C.

9. The process according to claim 1, wherein the duration of the crystallization step is between a few minutes and several hours, most often for a period varying from 30 minutes to 5 hours.

10. The process according to claim 1, wherein the flow rate is between 0.02 m³ h⁻¹ and 20 m³h⁻¹.

11. The process according to claim 1, wherein the crystals have a relative crystallinity, measured according to standard ASTM D5758, of between 95% and 140%.
